(19) United States
(12) Patent Application Publication
(10) Pub. No.: US 2014/0285810 A1
(43) Pub. Date: Sep. 25, 2014

(54) APPARATUS AND METHOD FOR FACILITATING MESOSCOPIC SPECTRALLY ENCODED TOMOGRAPHY CO-REGISTERED WITH OPTICAL FREQUENCY DOMAIN IMAGING AND/OR SPECTRALLY ENCODED CONFOCAL MICROSCOPY

(71) Applicants: PAULINO VACAS JACQUES, Boston, MA (US); JOSEPH A. GARDECKI, Acton, MA (US); GUILLERMO J. TEARNEY, Cambridge, MA (US)

(72) Inventors: PAULINO VACAS JACQUES, Boston, MA (US); JOSEPH A. GARDECKI, Acton, MA (US); GUILLERMO J. TEARNEY, Cambridge, MA (US)

(73) Assignee: The General Hospital Corporation, Boston, MA (US)

(21) Appl. No.: 14/167,153

(22) Filed: Jan. 29, 2014

Related U.S. Application Data
(60) Provisional application No. 61/758,130, filed on Jan. 29, 2013.
(60) Provisional application No. 61/791,996, filed on Mar. 15, 2013.

(51) Int. Cl. G01B 9/02

(52) U.S. Cl. CPC G01B 9/02091
USPC 356/479

(57) ABSTRACT

An apparatus for illuminating a sample(s) can be provided. For example, a first arrangement can transmit a first electro-magnetic radiation and a second electro-magnetic radiation; the first and second electro-magnetic radiations can have different wavelengths from one another. The first arrangement can transmit the first and second electro-magnetic radiations to different spatial locations on the sample(s). A second arrangement(s) can be configured to receive a third radiation(s) provided from the sample(s), the third radiation(s) can be associated with an interaction of the first and second electro-magnetic radiations in the sample(s). A processing third arrangement can be configured to receive, from the second arrangement, at least one fourth radiation that can be based on the third radiation(s), and generate information regarding a sub-surface portion(s) of the sample(s) based on the fourth radiation.

### CROSS-REFERENCE TO RELATED APPLICATION(S)

This application relates to and claims priority from U.S. Patent Application Ser. No. 61/758,130 filed Jan. 29, 2013 and U.S. Patent Application Ser. No. 61/791,996 filed Mar. 15, 2013, the entire disclosures of which are incorporated herein by reference.

### STATEMENT REGARDING FEDERALLY SPONSORED RESEARCH

This invention was made with Government support under grant number NIH 2R01HL076398-06 awarded by the National Institute of Health. The Government has certain rights therein.

### FIELD OF THE DISCLOSURE

The present disclosure relates generally to exemplary methods and apparatus for providing mesoscopic optical imaging of structures in a catheter, and more particularly to exemplary embodiments of methods, systems and apparatus for providing and/or utilizing mesoscopic spectrally encoded tomography (MSET) of structures in a catheter.

### BACKGROUND INFORMATION

A majority of diseases arise within luminal organs such as the coronary arteries and the gastrointestinal tract. Understanding and diagnosis of these diseases can require knowledge of their gross and microscopic structure.

An optical imaging catheter has become an important tool to assess and diagnose diseases arising from luminal organs. Since many of the mechanisms involving diseases occur on a microscopic scale, high-resolution imaging techniques have become relevant. Two important techniques for high-resolution imaging are optical frequency domain imaging (OFDI) and spectrally encoded confocal microscopy (SECM), where rotationally scanning catheters can be used for studying the cross-sectional and three-dimensional microstructure of luminal tissues. However, e.g., OFDI and SECM provide information at a maximum depth of 1-2 millimeters. Therefore, a method to perform optical imaging of structures located at greater depths would be valuable.

To address this unmet need and advance catheter-based diagnosis, it may be possible to utilize other optical tomography techniques, such as, e.g., laminar optical tomography (LOT) or diffuse optical tomography (DOT). LOT facilitates imaging of absorbing or fluorescent contrast in tissues to depths of 2-3 millimeters, in the so-called mesoscopic regime. Meanwhile, the domain of DOT has been on the order of centimeters, with breast and brain as two of the more common tissues of interest. The resolution of LOT is 100-200 micrometers, whereas DOT exhibits a resolution of several millimeters. However, neither LOT nor DOT has been implemented as a catheter-based solution.

Accordingly, there may be a need to address at least some of the above-described deficiencies.

### SUMMARY OF EXEMPLARY EMBODIMENTS

It is one of the objects of the present invention to provide a catheter-based approach to perform mesoscopic optical tomography. In accordance with certain exemplary embodiments of the present disclosure, exemplary methods and apparatus can be provided, which enable the implementation of spectrally encoded mesoscopic tomography of structures in a catheter.

Another one of the objects of the present disclosure is to provide a catheter-based approach to perform optical tomography at greater depths, and more specifically in the mesoscopic regime.

In order to perform mesoscopic optical tomography in a catheter, we propose to spectrally encode multiple wavelengths to generate different sources at specific spatial locations. Furthermore, we collect the information from each source separately by spectral-encoded detection of light coming out of the sample. A source-detector separation of, e.g., at most 10 mm can indicate that information from approximately 5 mm deep within the tissue can be collected, thus facilitating the assessment of the mesoscopic region. The exemplary technique can be flexible in terms of providing different source-detector arrangements by modifying the spectral encoding scheme.

Catheter-based mesoscopic spectrally encoded tomography can be performed in conjunction with exemplary embodiments of the devices, apparatus and methods according to the present disclosure utilizing steady state, time-resolved, and/or frequency-resolved data. The utilization of such exemplary information facilitates a determination of the optical parameters of the sample. In an exemplary tomography setup according to an exemplary embodiment of the present disclosure, such data can facilitate a reconstruction of the domain under review.

Further, according to one exemplary embodiment of the present disclosure, a device/apparatus can be provided which can include a mesoscopic spectrally encoded tomography-optical frequency domain imaging/spectrally encoded confocal microscopy (MSET-OFDI/SECM) catheter that illuminates the tissues and collects signals from the inside of the lumen, a MSET-OFDI/SECM system which generates light sources, detects returning lights, and processes signals, and a MSET-OFDI/SECM rotary junction which rotates and pulls back the catheter and connects the moving catheter to the stationary system. In another exemplary embodiment, a dual-modality catheter system can be provided for simultaneous microstructural and deep imaging of arteries in vivo. Any of these embodiments can benefit from the use of steady state, time-resolved, and/or frequency-resolved data.

For example, according to one exemplary embodiment of the present disclosure, an arrangement can provide electro-magnetic radiation to an anatomical structure through one optical fiber. Such exemplary arrangement can employ the same fiber to perform OFDI/SECM imaging, and an adjacent fiber for MSET. The arrangement can also include at least one apparatus, which is configured to transmit the radiation(s) via OFDI/SECM and MSET fiber(s) to and from the anatomical structure.

The exemplary apparatus can be provided in an optical coherence tomography system. Further, a system can be provided which obtains information regarding the anatomical structure and deeper structural information based on the radiation(s) using spectrally encoded mesoscopic tomography.

The exemplary apparatus can also be provided in a probe, a catheter, an eye box, an endoscope, etc. Further, at least one additional fiber can at least be located adjacent to the other fiber(s). In addition, at least one additional fiber can at least be located adjacent to the other fiber(s). Also, spectrally encoded mesoscopic tomography can be performed with at least one fiber with multiple cores.

According to yet another exemplary embodiment of the present disclosure, method and computer-accessible medium can be provided for determining at least one characteristic of at least one structure or composition. Using such method and/or computer-accessible medium, it is possible to receive first data associated with the structure(s), where the first data include information which facilitates a correction of a physical parameter associated with the structure(s). Second data associated with at least one structure or composition can be received which is different from the first data. The first and second data can be obtained from substantially the same location on or in the structure(s). Further information associated with the second data can be ascertained based on the physical parameter. Then, the characteristic(s) of at least one structure or composition can be determined based on the further data. These data include at least one of the following: steady state, time-resolved, and frequency-resolved data.

For example, the first data can include optical coherence tomography data. The second data can include mesoscopic spectrally encoded tomography data. The physical parameter can be the size of a deeply embedded tissue, internal structure, etc. The further information can include absorption and/or scattering properties of the tissue(s). The computer-accessible medium can include instructions. When the instructions are executed by a computer arrangement, the computer arrangement is configured to perform the above-described exemplary procedures.

According to yet further exemplary embodiment of the present disclosure, an arrangement can be provided for transmitting at least one electro-magnetic radiation between at least two separate waveguides in an optical fiber. Such exemplary arrangement can include at least one first waveguide, and at least one second waveguide, where the optical fiber, which contains the first waveguide(s) and/or the second waveguide(s), can be rotatable. At least one first optical arrangement can be provided which communicates with the first waveguide and/or the second waveguide to transmit the at least one electro-magnetic radiation there through. At least one second arrangement can be provided which is configured to rotate the first optical fiber which contains the first waveguide and/or the second waveguide.

At least one fourth arrangement can also be provided which is configured to generate at least one image of a sample as a function of the first optical coherence tomography radiation and the second mesoscopic spectrally encoded tomography radiation. The generated image(s) can be provided for an anatomical structure (e.g., a lumen).

According to further exemplary embodiments of the present disclosure, an arrangement can be provided for performing exclusively mesoscopic spectrally encoded tomography in a single waveguide of an optical fiber. Mesoscopic spectrally encoded tomography can be performed by utilizing steady state, time-resolved, and frequency-resolved data.

The exemplary MSET technique can be performed individually and in conjunction with optical frequency domain imaging (OFDI) or spectrally encoded confocal microscopy (SECM). According to certain exemplary embodiments, it is possible to provide system, apparatus and method to facilitate an acquisition of mesoscopic information from tissue by employing steady state, time-resolved, and/or frequency-resolved MSET data.

These and other objects of the present disclosure can be achieved by provision of an apparatus for illuminating a sample(s) that can include, for example, a first arrangement that can transmit a first electro-magnetic radiation and a second electro-magnetic radiation, the first and second electro-magnetic radiations can have different wavelengths from one another. The first arrangement can transmit the first and second electro-magnetic radiations to different spatial locations on the sample(s). A second arrangement(s) can be configured to receive a third radiation(s) provided from the sample(s), the third radiation(s) can be associated with an interaction of the first and second electro-magnetic radiations in the sample(s). A processing third arrangement can be configured to receive, from the second arrangement, at least one fourth radiation that can be based on the third radiation(s), and generate information regarding a sub-surface portion(s) of the sample(s) based on the fourth radiation.

In some exemplary embodiments of the present disclosure, the first and second arrangements can be spatially separated from one another. The separation can be by more than 1 mm, more than 2 mm, more than 5 mm, and/or more than 10 mm. The processing third arrangement(s) can generate the information by applying a diffuse, a mesoscopic tomography or a reconstruction procedure to obtain a composition or a structure of the at least one sub-surface portion.

In certain exemplary embodiments of the present disclosure, the first arrangement and/or the second arrangement can include a waveguide arrangement. The waveguide arrangement can include an optical fiber arrangement, which can include a fiber bundle. The first arrangement and/or the second arrangement can include a dispersive optical arrangement. The first arrangement and/or the second arrangement can include a lens arrangement. In certain exemplary embodiments of the present disclosure, the first arrangement and/or the second arrangement can be provided in a housing, which can be structured to be provided into the sample(s) which can be an anatomical structure. The housing can be part of a catheter or an endoscope.

In some exemplary embodiments of the present disclosure, a fourth arrangement can be configured to receive a fifth electro-magnetic radiation from the second arrangement(s) that can be based on third radiation(s), the fourth arrangement can provide data that can be of reflectance confocal microscopy, SECM, OFDI, SD-OCT, FFOCM, 2^{nd} and 3^{rd} harmonic microscopy, fluorescence microscopy or RAMAN. A laser source can provide a source radiation for receipt by the first arrangement. In certain exemplary embodiments of the present disclosure, a light modulating arrangement can be configured to modulate an intensity of the first and second electro-magnetic radiations, thereby modulating an intensity of the third radiation. The processing arrangement can obtain the intensity information regarding the modulation and a phase of the third radiation. The processing arrangement can utilize information regarding a modulation and a phase to generate further information regarding the sample(s). The further information can be tomographic information, structural information, compositional information or optical property information.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF DRAWINGS

Further objects, features and advantages of the present disclosure will become apparent from the following detailed description taken in conjunction with the accompanying figures showing illustrative embodiments of the present disclosure, in which:

FIG. 1(a) is a side cross-sectional view of a mesoscopic spectrally encoded tomography-optical frequency domain imaging (MSET-OFDI) optical imaging catheter with a side-viewing ball lens, and a conventional diffractive element for MSET detection, according to one exemplary embodiment of the present disclosure;

FIG. 1(b) is a side cross-sectional view of a mesoscopic spectrally encoded tomography-optical frequency domain imaging (MSET-OFDI) optical imaging catheter with a side-viewing ball lens, and a grazing configuration of the diffractive element to facilitate deeper imaging in the MSET detection, according to another exemplary embodiment of the present disclosure;

FIG. 2(a) is a side cross-sectional view of a mesoscopic spectrally encoded tomography-spectrally encoded confocal microscopy (MSET-SECM) optical imaging catheter with a reflective/diffractive component for SECM, and a diffractive element for MSET, according to still exemplary embodiment of the present disclosure;

FIG. 2(b) is a side cross-sectional view of a mesoscopic spectrally encoded tomography-spectrally encoded confocal microscopy (MSET-SECM) optical imaging catheter, where both diffractive elements are used in a grazing configuration to permit deeper imaging, according to yet another exemplary embodiment of the present disclosure;

FIG. 3(a) is a side cross-sectional view of a standalone mesoscopic spectrally encoded tomography (MSET) optical imaging catheter with one source and multiple detectors according to one exemplary embodiment of the present disclosure;

FIG. 3(b) is a side cross-sectional view of a standalone mesoscopic spectrally encoded tomography (MSET) optical imaging catheter with multiple sources and multiple detectors according to a further exemplary embodiment of the present disclosure;

FIG. 4(a) is a schematic diagram and a bench-top embodiment of a mesoscopic spectrally encoded tomography-optical frequency domain imaging (MSET-OFDI) system, the setup also represents a standalone MSET with one source and multiple detectors according to still another embodiment of the present disclosure;

FIG. 4(b) is a schematic diagram and a bench-top embodiment of a mesoscopic spectrally encoded tomography-spectrally encoded confocal microscopy (MSET-SECM) system, the setup also represents a standalone MSET with multiple sources and multiple detectors according to a further exemplary embodiment of the present disclosure;

FIG. 5(a) is an exemplary image of a tissue-mimicking phantom with one inclusion and the corresponding MSET experimental results by utilizing the exemplary methods, devices and apparatus according to the present disclosure; and

FIG. 5(b) is an exemplary image of a tissue-mimicking phantom with two inclusions and the corresponding MSET experimental results by utilizing the exemplary methods, devices and apparatus according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

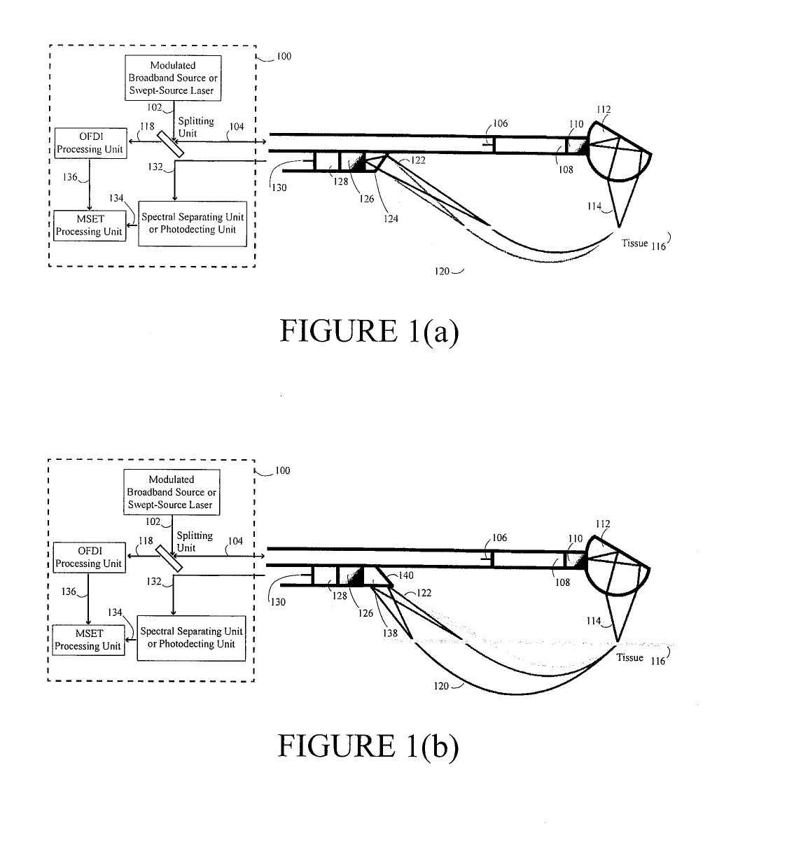

FIG. 1(a) shows a side cross-sectional view of a mesoscopic spectrally encoded tomography-optical frequency domain imaging (MSET-OFDI) optical imaging catheter with a side-viewing ball lens, and a conventional diffractive element for MSET detection, according to one exemplary embodiment of the present disclosure. In particular, as shown in FIG. 1(a), an MSET-OFDI system 100 is employed. A modulated broadband or swept-source light 102 is split 104 and delivered through a fiber 106. Optical elements 108, 110, and 112 (e.g., spacer and lenses) can be used to focus the light 114 onto the sample 116. An arrangement of diffractive element 124, lens 126, spacer 128, and output fiber 130, can serve to spectrally detect 122 scattered light 120 coming from different depths within the sample. Information for Optical Frequency Domain Imaging 118 may be obtained from the output of fiber 106 after traversing the splitting unit. Steady state, time-resolved, and/or frequency-resolved data 134 can be obtained after spectral separation or photodetection 132 from the output MSET fiber 130. MSET information, including a structural reconstruction, can be obtained from the OFDI processing unit output 136 and the steady state, time-resolved, and/or frequency-resolved data 134. Exemplary elements in FIG. 1(a) are as follows: MSET-OFDI system 100, fiber 106,130, spacer 108,128, lens 110,126, ball lens 112, and diffractive element 124.

FIG. 1(b) shows a side cross-sectional view of the MSET-OFDI optical imaging catheter with a side-viewing ball lens, and a grazing configuration of the diffractive element to facilitate deeper imaging in the MSET detection, according to another exemplary embodiment of the present disclosure. In particular, as shown in FIG. 1(b), an MSET-OFDI system 100 is employed. A modulated broadband or swept-source light 102 is split 104 and delivered through a fiber 106. Optical elements 108, 110, and 112 (e.g., spacer and lenses) can be used to focus the light 114 onto the sample 116. The arrangement of reflective element 140, diffractive element 138, lens 126, spacer 128, and output fiber 130, can serve to spectrally detect 122 scattered light 120 coming from different depths within the sample. The diffractive element 138 can be used in a grazing configuration to enable wide spectral separation. Information for Optical Frequency Domain Imaging 118 may be obtained from the output of fiber 106 after traversing the splitting unit. Steady state, time-resolved, and/or frequency-resolved data 134 can be obtained after spectral separation or photodetection 132 from the output MSET fiber 130. MSET information, including a structural reconstruction, can be obtained from the OFDI processing unit output 136 and the steady state, time-resolved, and/or frequency-resolved data 134. Exemplary elements in FIG. 1(b) are as follows: MSET-OFDI system 100, fiber 106,130, spacer 108,128, lens 110,126, ball lens 112, reflective element 140, and diffractive element 138 at grazing configuration.

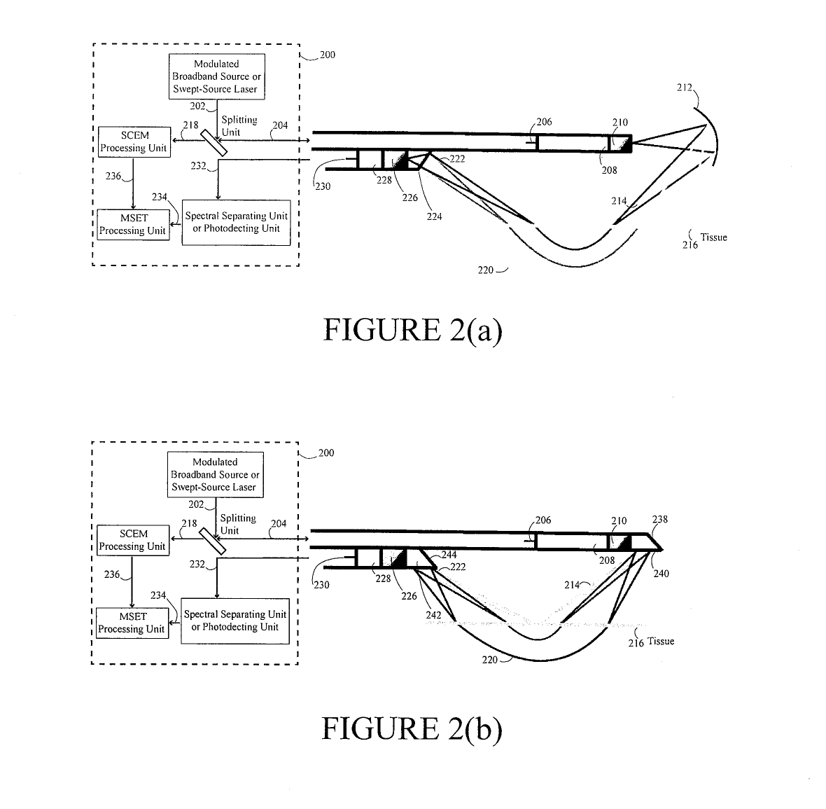

FIG. 2(a) shows a side cross-sectional view of the MSET-SECM optical imaging catheter with a reflective/diffractive component for SECM, and a diffractive element for MSET, according to still exemplary embodiment of the present disclosure. In particular, as shown in FIG. 2(a), an MSET-SECM system 200 is employed. A modulated broadband or swept-source light 202 is split 204 and delivered through a fiber 206. With elements 208, 210, and 212 (e.g., spacer, lens, and reflective/diffractive element), different wavelengths are encoded spectrally to generate multiple sources 214 at different spatial points on the sample 216. The arrangement of diffractive element 224, lens 226, spacer 228, and output fiber 230, serve to spectrally detect 222 scattered light 220 coming from different depths within the sample. Information for Spectrally Encoded Confocal Microscopy 218 may be obtained from the output of fiber 206 after traversing the splitting unit. Steady state, time-resolved, and/or frequency-resolved data 234 may be obtained after spectral separation or photodetection 232 from the output MSET fiber 230. MSET information, including a structural reconstruction, may be obtained from the SECM processing unit output 236 and the steady state, time-resolved, and/or frequency-resolved data 234. Exemplary elements in FIG. 2(a) are as follows: MSET-SECM system 200, fiber 206,230, spacer 208,228, lens 210,226, reflective/diffractive element 212, and diffractive element 224.

FIG. 2(b) shows a side cross-sectional view of the MSET-SECM optical imaging catheter, where both diffractive elements are used in a grazing configuration to permit deeper imaging, according to yet another exemplary embodiment of the present disclosure. In particular, as shown in FIG. 2(b), an MSET-SECM system 200 is employed. A modulated broadband or swept-source light 202 is split 204 and delivered through a fiber 206. With elements 208, 210, 238, and 240 (e.g., spacer, lens, reflective element, and diffractive element), different wavelengths can be encoded spectrally to generate multiple sources 214 at different spatial points on the sample 216. The exemplary arrangement of diffractive element 242, reflective element 244, lens 226, spacer 228, and output fiber 230, can serve to spectrally detect 222 scattered light 220 coming from different depths within the sample. Exemplary grazing configurations, both for input and output ports, can facilitate wide source-detector separations, and thus deeper imaging. Information for Spectrally Encoded Confocal Microscopy 218 may be obtained from the output of fiber 206 after traversing the splitting unit. Steady state, time-resolved, and/or frequency-resolved data 234 may be obtained after spectral separation or photodetection 232 from the output MSET fiber 230. MSET information, including a structural reconstruction, may be obtained from the SECM processing unit output 236 and the steady state, time-resolved, and/or frequency-resolved data 234. Exemplary elements in FIG. 2(b) are as follows: MSET-SECM system 200, fiber 206,230, spacer 208,228, lens 210,226, reflective element 238,244, and diffractive element 240,242 at grazing configuration.

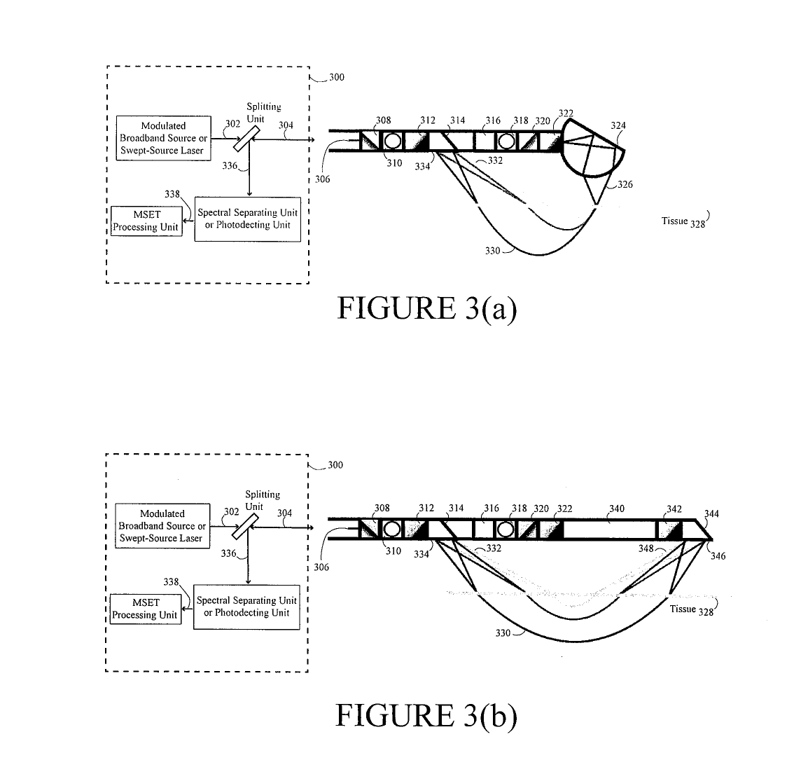

FIG. 3(a) shows a side cross-sectional view of a standalone mesoscopic spectrally encoded tomography (MSET) optical imaging catheter with one source and multiple detectors according to one exemplary embodiment of the present disclosure. In particular, as shown in FIG. 3(a), a MSET system 300 is employed. A modulated broadband or swept-source light 302 is split 304, delivered, and collected through a fiber 306. A −45 deg. polarizer, followed by a 45 deg. polarization rotator can be used to selectively transmit light through a polarization sensitive splitting unit (e.g., components 308, 310, and 314). Additionally, light reflected at the splitting unit can also be minimized. Elements 314, 316, 318, and 320 (e.g., polarization sensitive splitting unit, spacer, 45 deg. polarization rotator, and 45 deg. polarizer) can function as one or more optical isolators. Lenses 312, 322, and 324 can be used to relay and focus light 326 onto the sample 328. The perpendicularly polarized component of the scattered light 330 can be spectrally detected 332 by the diffractive element, splitting unit, lens, rotator, and polarizer (see, e.g., components 334, 314, 312, 310, and 308). A non-reciprocal element, such as a circulator, can be used to isolate the diffuse light. It is possible to use a diffractive element in a grazing configuration to enable wide spectral separation. Steady state, time-resolved, and/or frequency-resolved data 338 may be obtained after spectral separation or photodetection 336 from the output fiber 306. MSET information, including a structural reconstruction, may be obtained from the steady state, time-resolved, and/or frequency-resolved data 338. Exemplary elements in FIG. 3(a) are as follows: MSET system 300, fiber 306, −/+45 deg. Polarizer 308,320, 45 deg. polarization rotator 310,318, lens 312,322, polarization sensitive splitting unit 314, diffractive element 334, a spacer 316, and ball lens 324.

FIG. 3(b) shows a side cross-sectional view of the MSET optical imaging catheter with multiple sources and multiple detectors according to a further exemplary embodiment of the present disclosure. In particular, as shown in FIG. 3(b), a MSET system 300 is employed. A modulated broadband or swept-source light 302 is split 304, delivered, and collected through a fiber 306. A −45 deg. polarizer, followed by a 45 deg. polarization rotator can be used to selectively transmit light through a polarization sensitive splitting unit (see, e.g., components 308, 310, and 314). Additionally, light reflected at the splitting unit can also be reduced and/or minimized. Elements 314, 316, 318, and 320 (e.g., polarization sensitive splitting, spacer, 45 deg. polarization rotator, and 45 deg. polarizer) can function as one or more optical isolators. Lenses 312, 322, and 342 can be used to relay light. With spacer 340, lens 342, reflective element 344, and diffractive element 346, e.g., different wavelengths can be encoded spectrally to generate multiple sources 348 at different spatial points on the sample 328. The perpendicularly polarized component of the scattered light 330 can be spectrally detected 332 by the diffractive element, splitting unit, lens, rotator, and polarizer (see, e.g., components 334, 314, 312, 310, and 308). A non-reciprocal element, such as a circulator, can be used to isolate the diffuse light. Grazing exemplary configurations, both for input and output ports, can facilitate wide source-detector separations, and thus deeper imaging. Steady state, time-resolved, and/or frequency-resolved data 338 may be obtained after spectral separation or photodetection 336 from the output fiber 306. MSET information, including a structural reconstruction, may be obtained from the steady state, time-resolved, and/or frequency-resolved data 338. Exemplary elements in FIG. 3(b) are as follows: MSET system 300, fiber 306, −/+45 deg. Polarizer 308,320, 45 deg. polarization rotator 310,318, lens 312,322,342, polarization sensitive splitting unit 314, diffractive element 346,334, spacer 316,340, and reflective element 344.

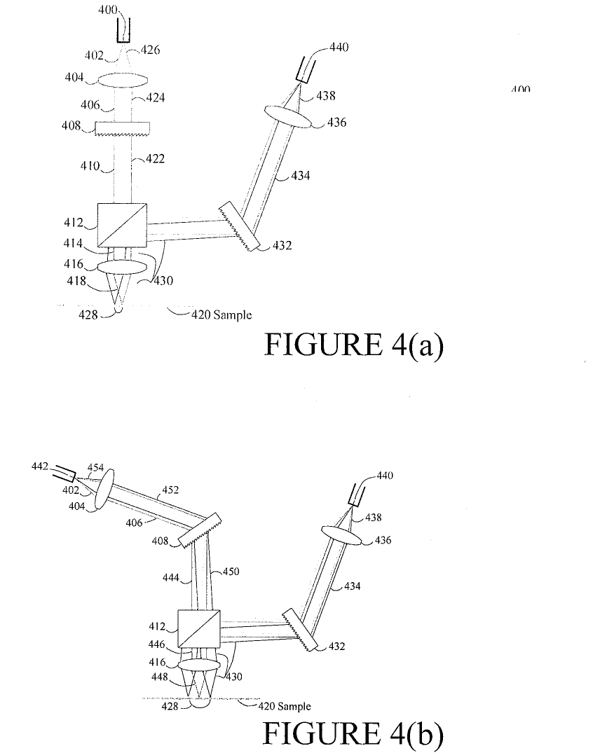

FIG. 4(a) shows a schematic diagram and a bench-top embodiment of the MSET-OFDI system, the setup also representing a standalone MSET system with one source and multiple detectors according to still another embodiment of the present disclosure. This exemplary configuration can be equivalent to the one employed with an exemplary MSET-OFDI system and can be utilized to study external organs or other bench-top samples. In particular, as shown in FIG. 4(a), modulated broadband or swept-source light 402 is delivered through a fiber 400, employed on the return path for Optical Frequency Domain Imaging. Optical elements 404, 408, 412, and 416 (e.g., lenses, diffractive element, and splitting unit) can be used to collimate 406, diffract (zero-order diffraction shown) 410, split 414, and focus the light 418 onto the sample 420. An arrangement of lens 416, splitting unit 412, and diffractive element 432, can serve to spectrally detect 430 scattered light 428 coming from different depths within the sample. The spectrally detected light 430 is collimated 434 and coupled 438, through use of at least one lens 436, into the output MSET fiber 440. Information for OFDI may be obtained after the reflected light 418 from the sample is split 422, diffracted 424, and coupled 426 into the output OFDI fiber 400. Steady state, time-resolved, and/or frequency-resolved data can be obtained after spectral separation or photodetection from the output MSET fiber 440. Exemplary elements in FIG. 4(a) are as follows: fiber 400,440, lens 404,416,436, splitting unit 412, and diffractive element 408,432.

FIG. 4(b) shows a schematic diagram and an exemplary bench-top embodiment of the MSET-SECM system, the setup also representing a standalone MSET system with multiple sources and multiple detectors according to a further exemplary embodiment of the present disclosure. This exemplary configuration can be equivalent to the one employed in an exemplary embodiment of the MSET-SECM system and may be used to assess external organs or other bench-top samples. In particular, as shown in FIG. 4(b), modulated broadband or swept-source light 402 is delivered through a fiber 442, utilized on the return path for Spectrally Encoded Confocal Microscopy. Optical elements 404, 408, 412, and 416 (e.g., lenses, diffractive element, and splitting unit) can be used to collimate 406, diffract 444, split 446, and focus the light 448 onto the sample 420. An arrangement of lens 416, splitting unit 412, and diffractive element 432, can serve to spectrally detect 430 scattered light 428 coming from different depths within the sample. The spectrally detected light 430 is collimated 434 and coupled 438, through use of at least one lens 436, into the output MSET fiber 440. Information for SECM may be obtained after the reflected light 448 from the sample is split 450, diffracted 452, and coupled 454 into the output SECM fiber 442. Steady state, time-resolved, and/or frequency-resolved data can be obtained after spectral separation or photodetection from the output MSET fiber 440. Exemplary elements in FIG. 4(b) are as follows: fiber 442,440, lens 404,416,436, splitting unit 412, and diffractive element 408,432.

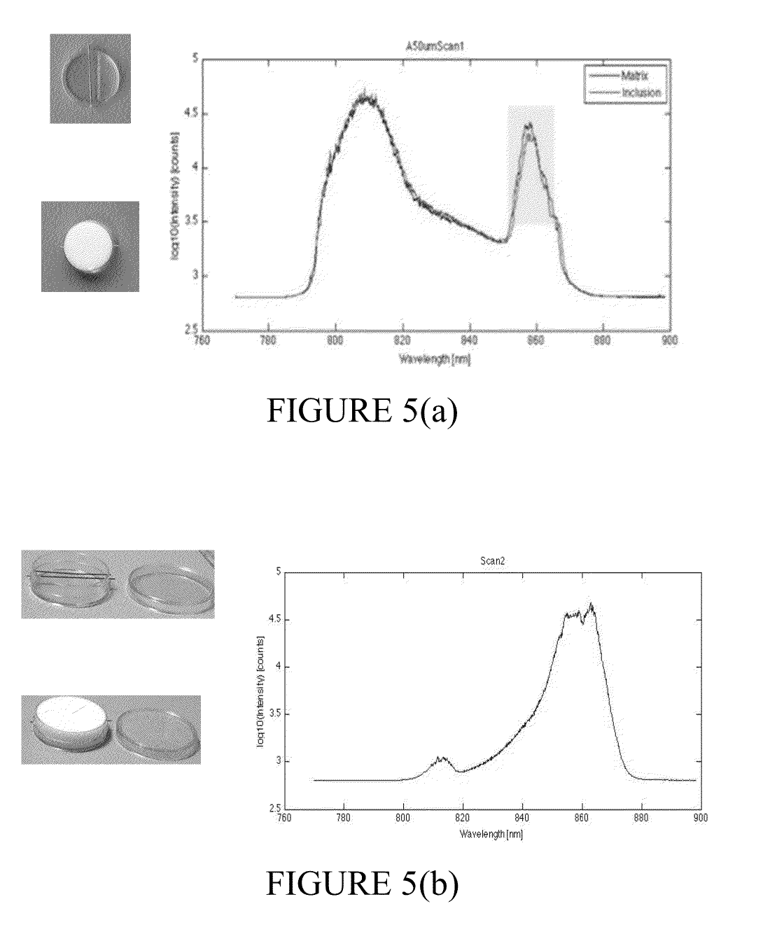

FIG. 5(a) illustrates an exemplary image of a tissue-mimicking phantom with one inclusion and the corresponding MSET experimental results by utilizing the exemplary methods, devices and apparatus according to the present disclosure. FIG. 5(b) is an exemplary image of a tissue-mimicking phantom with two inclusions and the corresponding MSET experimental results by utilizing the exemplary methods, devices and apparatus according to the present disclosure.

The foregoing merely illustrates the principles of the disclosure. Various modifications and alterations to the described embodiments will be apparent to those skilled in the art in view of the teachings herein. Indeed, the arrangements, systems and methods according to the exemplary embodiments of the present disclosure can be used with and/or implement any OCT system, OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as U.S. Patent Publication No. 2006/0093276 on May 4, 2006, and U.S. patent application Ser. No. 10/501,276, filed Jul. 9, 2004 which published as U.S. Patent Publication No. 2005/0018201 on Jan. 27, 2005, and U.S. Patent Publication No. 2002/0122246, published on May 9, 2002, the disclosures of which are incorporated by reference herein in their entireties. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety. All publications referenced above can be incorporated herein by reference.

What is claimed is:

1. An apparatus for illuminating at least one sample, comprising:
at least one first arrangement which transmits a first electro-magnetic radiation and a second electro-magnetic radiation, wherein the first and second electro-magnetic radiations have different wavelengths from one another, and wherein the at least one first arrangement transmits the first and second electro-magnetic radiations to different spatial locations on the at least one sample; and
at least one second arrangement which is configured to receive at least one third radiation provided from the at least one sample, wherein the at least one third radiation is associated with an interaction of at least one of (i) the first electro-magnetic radiation or (ii) the second electro-magnetic radiations with the at least one sample; and
at least one processing third arrangement which is configured to:
(i) receive, from the second arrangement, at least one fourth radiation that is based on the at least one third radiation, and
(ii) generate information regarding at least one sub-surface portion of the at least one sample based on the fourth radiation.

2. The apparatus according to claim 1, wherein the first and second arrangements are spatially separated from one another.

3. The apparatus according to claim 2, wherein the first and second arrangements are spatially separated from one another by more than 1 mm.

4. The apparatus according to claim 3, wherein the first and second arrangements are spatially separated from one another by more than 2 mm.

5. The apparatus according to claim 4, wherein the first and second arrangements are spatially separated from one another by more than 5 mm.

6. The apparatus according to claim 5, wherein the first and second arrangements are spatially separated from one another by more than 10 mm.

7. The apparatus according to claim 1, wherein the at least one computer third arrangement generates the information by applying a diffuse or mesoscopic tomography or reconstruction procedure to obtain a composition or a structure of the at least one sub-surface portion.

8. The apparatus according to claim 1, wherein at least one of the first arrangement or the second arrangement includes a waveguide arrangement.

8A. The apparatus according to claim 1, wherein the waveguide arrangement includes an optical fiber arrangement.

9. The apparatus according to claim 1, wherein the optical fiber arrangement includes a fiber bundle.

10. The apparatus according to claim 1, wherein the first arrangement has a dispersive optical arrangement.

11. The apparatus according to claim 1, wherein the second arrangement has a dispersive optical arrangement.

12. The apparatus according to claim 1, wherein each of the first and second arrangements has a dispersive optical arrangement.

13. The apparatus according to claim 1, wherein at least one of the first arrangement or the second arrangement includes a lens arrangement.

14. The apparatus according to claim 1, wherein at least one of the first arrangement or the second arrangement are provided in a housing.

15. The apparatus according to claim 1, wherein the housing is structured to be provided into the at least one sample which is an anatomical structure.

16. The apparatus according to claim 1, wherein the housing is part of a catheter or an endoscope.

17. The apparatus according to claim 1, further comprising a fourth arrangement which is configured to receive a fifth electro-magnetic radiation from the at least one second arrangement that is based on the at least one third radiation, wherein the fourth arrangement provides data that is at least one of reflectance confocal microscopy, SECM, OFDI, SD-OCT, FFOCM, second and third harmonic microscopy, fluorescence microscopy or RAMAN spectroscopy.

18. The apparatus according to claim 1, further comprising a laser source providing a source radiation for receipt by the first arrangement.

19. The apparatus according to claim 1, further comprising a light modulating arrangement which is configured to modulate an intensity of the first and second electro-magnetic radiations, thereby modulating an intensity of the third radiation.

20. The apparatus according to claim 19, wherein the processing arrangement obtains the intensity information regarding the modulation and a phase of the third radiation.

21. The apparatus according to claim 20, wherein the processing arrangement utilizes information regarding the modulation and the phase to generate further information regarding the at least one sample.

22. The apparatus according to claim 21, wherein the further information is at least one of tomographic information, structural information, compositional information, optical property information.

23. A method for illuminating at least one sample, comprising:
transmitting a first electro-magnetic radiation and a second electro-magnetic radiation, wherein the first and second electro-magnetic radiations have different wavelengths from one another, and the first and second electro-magnetic radiations are transmitted to different spatial locations on the at least one sample; and
receiving at least one third radiation provided from the at least one sample, wherein the at least one third radiation is associated with an interaction of at least one of (i) the first electro-magnetic radiation or (ii) the second electro-magnetic radiations with the at least one sample; and
receiving at least one fourth radiation that is based on the at least one third radiation, and generating information regarding at least one sub-surface portion of the at least one sample based on the fourth radiation.
